(19) United States
(12) Patent Application Publication
(10) Pub. No.: US 2025/0309811 A1
(43) Pub. Date: Oct. 2, 2025

(54) SWITCHING CONTROL DEVICE AND MOTOR SYSTEM

(71) Applicant: ROHM CO., LTD., Kyoto-shi (JP)

(72) Inventor: Takashi ESUMI, Kyoto-shi (JP)

(21) Appl. No.: 19/230,443

(22) Filed: Jun. 6, 2025

Related U.S. Application Data
(63) Continuation of application No. PCT/JP2023/037163, filed on Oct. 13, 2023.

(30) Foreign Application Priority Data
Dec. 14, 2022 (JP) 2022-199763

(51) Int. Cl. H02P 27/08

(52) U.S. Cl. CPC H02P 27/085

(57) ABSTRACT

A switching control device includes: a PWM duty cycle conversion unit configured to convert voltage command signals of three phases into PWM duty cycles; a PWM duty cycle adjustment unit configured to simultaneously adjust the PWM duty cycles of the three phases at the same time using the same adjustment value; a pulse generation unit configured to generate pulse signals from the PWM duty cycles adjusted by the PWM duty cycle adjustment unit; and an inverter circuit configured to include a plurality of switching elements that are driven by the pulse signals generated by the pulse generation unit.

### CROSS REFERENCE TO RELATED APPLICATIONS

This application is a continuation under 35 U.S.C. § 120 of. PCT/JP2023/037163 filed on Oct. 13, 2023, which claims priority Japanese Patent Application No. 2022-199763 filed on Dec. 14, 2022. The present application likewise claims priority under 35 U.S.C. § 119 to Japanese Application No. 2022-199763, filed Dec. 14, 2022, the entire contents of which are hereby incorporated by reference.

### TECHNICAL FIELD

An invention disclosed in the present specification relates to a switching control device and also relates to a motor system which uses a switching control device.

### BACKGROUND ART

Conventionally, among motor drive devices which drive a brushless DC motor, there is a motor drive device which drives a motor by PWM (pulse width modulation) based on a speed command signal (for example, Patent Document 1).

### RELATED ART DOCUMENT

### Patent Document

Patent Document 1: Japanese Unexamined Patent Application Publication No. 2022-104708

### BRIEF DESCRIPTION OF DRAWINGS

FIG. 1 is a schematic configuration diagram of a motor system;

FIG. 2 is a diagram showing ideal voltage signals and PWM waveforms when a motor is driven;

FIG. 3 is a diagram showing the waveforms of PWM duty cycles;

FIG. 4 is a flowchart showing a procedure for adjusting the PWM duty cycles;

FIG. 5 is an enlarged view of the waveforms of the PWM duty cycles showing the procedure for adjusting the PWM duty cycles;

FIG. 6 is a diagram showing the waveforms of the PWM duty cycles after being adjusted;

FIG. 7 is a diagram showing the waveforms of line voltages of a brushless DC motor;

FIG. 8 is a diagram showing the waveforms of PWM duty cycles;

FIG. 9 is a flowchart showing a procedure for performing line modulation on voltage command signals;

FIG. 10 is an enlarged view of the waveforms of the PWM duty cycles showing a procedure for adjusting the PWM duty cycles;

FIG. 11 is a diagram showing the waveforms of the PWM duty cycles after being adjusted;

FIG. 12 is a diagram showing the waveforms of line voltages of the motor;

FIG. 13 is a schematic configuration diagram of a motor system in a second variation;

FIG. 14 is a diagram showing an example of an operation for inserting a dead time;

FIG. 15 is a diagram showing the waveforms of PWM duty cycles on which line modulation and dead time compensation have been performed;

FIG. 16 is an enlarged view of the waveforms of the PWM duty cycles showing a procedure for adjusting the PWM duty cycles;

FIG. 17 is a diagram showing the waveforms of the PWM duty cycles after being adjusted;

FIG. 18 is a diagram showing the waveforms of line voltages of a motor;

FIG. 19 is a flowchart showing a procedure for adjusting PWM duty cycles in a third variation; and

FIG. 20 is an enlarged view of waveforms in the procedure for adjusting the PWM duty cycles using the flowchart shown in FIG. 19.

### DESCRIPTION OF EMBODIMENTS

In the present specification, a MOS (Metal Oxide Semiconductor) field effect transistor refers to a transistor in which a gate structure includes at least three layers of “a layer made of a conductor or a semiconductor such as polysilicon having a low resistance value”, “an insulating layer” and “a P-channel, N-channel or intrinsic semiconductor layer”. In other words, the gate structure of the MOS field effect transistor is not limited to a three-layer structure of a metal, an oxide and a semiconductor.

Embodiments will be described below with reference to drawings. In the present specification, a case where elements are connected to each other includes not only a case where they are mechanically connected but also a case where they are electrically connected, that is, a case where electricity flows. Hence, the case where “they are connected” includes the case where “they are electrically connected”.

### <Motor System 100>

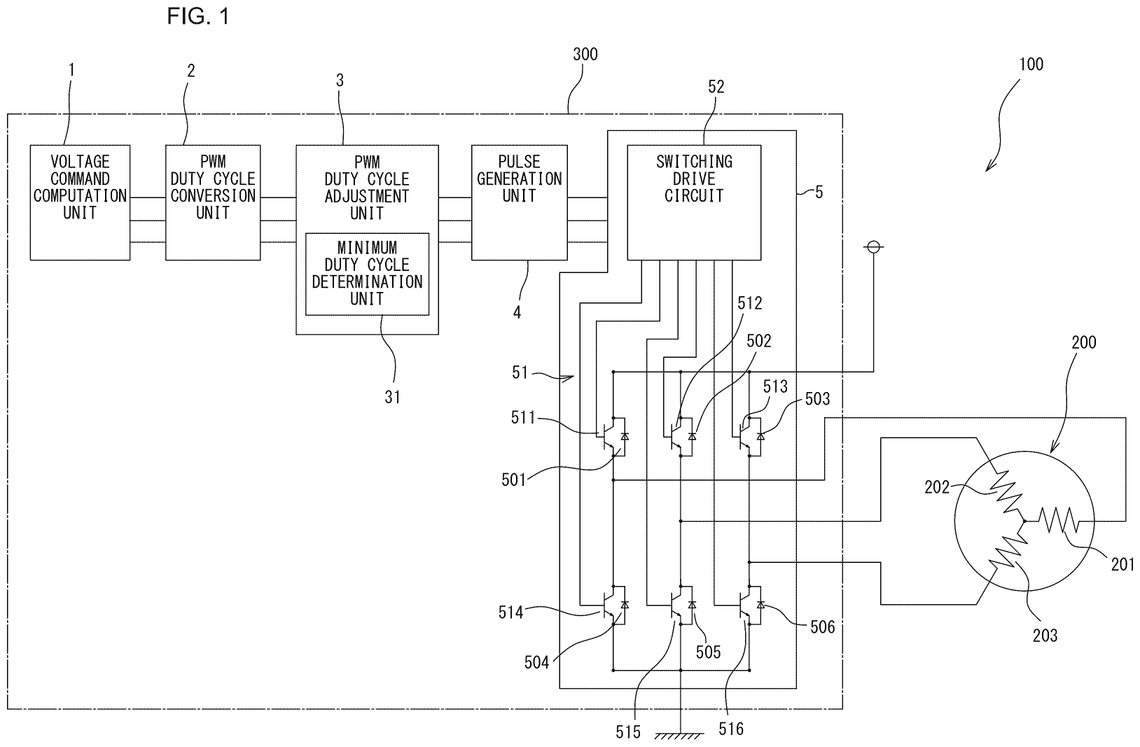

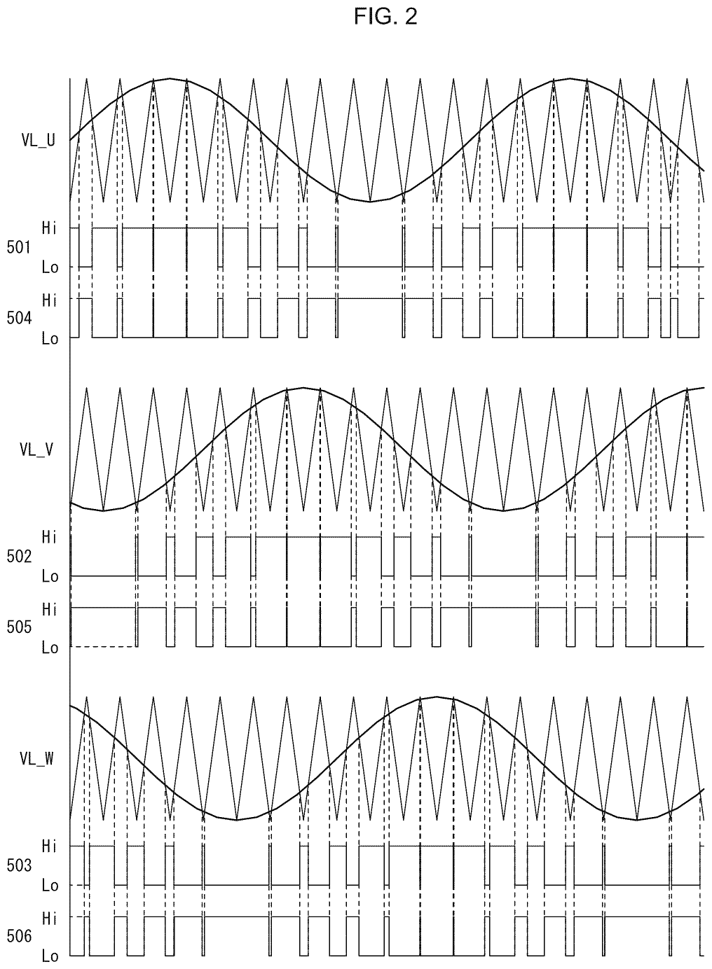

FIG. 1 is a schematic configuration diagram of a motor system 100. FIG. 2 is a diagram showing ideal voltage wavelengths and PWM waveforms when a motor is driven. The motor system 100 shown in FIG. 1 includes a motor 200 and a switching control device 300. The motor 200 is a brushless DC motor. The motor 200 includes a U-phase coil 201, a V-phase coil 202 and a W-phase coil 203. A voltage of an appropriate size is applied to each of the U-phase coil 201, the V-phase coil 202 and the W-phase coil 203 at an appropriate timing, and thus the motor 200 is rotated at a desired rotation speed.

A speed command signal for the motor 200 is supplied to the switching control device 300 from an unillustrated external drive control unit. The speed command signal includes information indicating the rotation speed of the motor 200 and information for the startup and stop of the motor 200. In other words, the switching control device 300 receives the speed command signal to drive the motor 200 at a speed specified by the speed command signal.

The switching control device 300 includes a voltage command computation unit 1, a PWM duty cycle conversion unit 2, a PWM duty cycle adjustment unit 3, a pulse generation unit 4 and an inverter circuit 5. In the switching control device 300 according to the present embodiment, the voltage command computation unit 1, the PWM duty cycle conversion unit 2, the PWM duty cycle adjustment unit 3 and the pulse generation unit 4 are digital processing units which perform digital processing. However, the present disclosure is not limited to this configuration, and the voltage command computation unit 1, the PWM duty cycle conversion unit 2, the PWM duty cycle adjustment unit 3 and the pulse generation unit 4 may be analog processing units. These processing units may be configured with one processing circuit or may be configured by a combination of different processing circuits. They may be provided as programs which can perform the processing with a computation circuit.

The voltage command computation unit 1 receives a speed control command from the drive control unit described above. The voltage command computation unit 1 calculates, based on the speed control command, the frequency and the amplitude of a voltage which is applied to each of the coils 201 to 203 of the phases in the motor 200. The voltage command computation unit 1 transmits the voltage command signals for the phases to the PWM duty cycle conversion unit 2. The voltage command signals include digital information equivalent to the voltage signals of sinusoidal waves shown in FIG. 2. The voltage command signals are assumed to be the voltage command signal VL_U of the U phase, the voltage command signal VL_V of the V phase and the voltage command signal VL_W of the W phase. The amplitude of the voltage command signal is represented by Vd.

The PWM duty cycle conversion unit 2 receives the voltage command signals from the voltage command computation unit 1 and PWM periods for converting into PWM signals. The PWM periods correspond to PWM carrier signals as shown in FIG. 2. In other words, the PWM periods are reference periods when the PWM signals are generated.

As shown in FIG. 2, the PWM duty cycle conversion unit 2 compares the voltage command signal and the PWM carrier signal to determine a PWM duty cycle. For example, as shown in FIG. 2, the PWM duty cycle is generated such that on is set when the voltage command signal is greater than the PWM carrier signal and off is set when the PWM carrier signal is greater than the voltage command signal. By another method, the PWM duty cycle may be determined.

The PWM duty cycle conversion unit 2 generates the PWM signal based on the voltage command signal and the PWM period and transmits the PWM signal to the PWM duty cycle adjustment unit 3. The PWM signals are generated for the voltage command signals VL_U, VL_V and VL_W of the three phases.

The PWM duty cycle adjustment unit 3 acquires the PWM duty cycles of the three phases based on the PWM signals transmitted from the PWM duty cycle conversion unit 2. The PWM duty cycle adjustment unit 3 includes a minimum duty cycle determination unit 31. The minimum duty cycle determination unit 31 determines, based on the PWM duty cycle, whether the width of the on period or the off period of the PWM signal is greater than a predetermined width.

The PWM duty cycle adjustment unit 3 adjusts, based on the determination performed by the minimum duty cycle determination unit 31, the PWM duty cycle which needs to be converted. The details of the adjustment of the PWM duty cycle will be described later. The PWM duty cycle adjustment unit 3 generates the PWM duty cycle and transmits the PWM duty cycle to the pulse generation unit 4.

The pulse generation unit 4 generates pulse signals of the three phases based on the PWM duty cycles from the PWM duty cycle adjustment unit 3. The pulse signals generated in the pulse generation unit 4 are voltage signals for driving the inverter circuit 5 and are analog signals.

The inverter circuit 5 is a circuit which applies a voltage to the U-phase coil 201, the V-phase coil 202 and the W-phase coil 203 of the motor 200. As shown in FIG. 1, the inverter circuit 5 includes an inverter main circuit 51 and a switching drive circuit 52.

The inverter main circuit 51 is a three-phase full bridge circuit which includes a U-phase leg, a V-phase leg and a W-phase leg. In each of the legs of the phases, the first end of an upper arm is configured to be supplied a voltage. The second end of the upper arm and the first end of a lower arm are connected in series. The second end of the lower arm is configured to be connectable to a ground potential.

The U-phase coil 201 is connected to a part where the upper arm and the lower arm of the U-phase leg are connected. The V-phase coil 202 is connected to a part where the upper arm and the lower arm of the V-phase leg are connected. Furthermore, the W-phase coil 203 is connected to a part where the upper arm and the lower arm of the W-phase leg are connected.

The upper arms and the lower arms include switching elements 511 to 516 such as bipolar transistors, MOS field effect transistors or IGBTs (Insulated Gate Bipolar Transistor) and free-wheeling diodes 501 to 506 which are connected in parallel to the switching elements. In the inverter circuit 5 in the present embodiment, the IGBTs are used as the switching elements 511 to 516.

When the MOS field effect transistors are used as the switching elements 511 to 516, body diodes which are added to the MOS field effect transistors can also be used as the free-wheeling diodes. In this way, it is possible to omit the free-wheeling diodes.

The pulse signals generated in the pulse generation unit 4 are input to the switching drive circuit 52. As described above, the pulse signals are the voltage signals, and for example, the switching drive circuit 52 amplifies the input voltage signals to generate switching signals and inputs the switching signals to the control nodes of the switching elements 511 to 516 (in the present embodiment, the gates of the IGBTs). In this way, the switching elements 511 to 516 are controlled to be on.

The pulse generation unit 4 may supply the voltage signals indicating the voltages of the U phase, the V phase and the W phase or may supply six pulse signals for driving the switching elements 511 to 516.

### <Operation of Inverter Circuit 5>

The operation of the inverter circuit 5 will be described with reference to drawings. FIG. 2 shows the voltage waveforms of the voltages applied from the inverter circuit 5 to the motor 200 and the PWM signals for driving the switching elements 511 to 516.

As shown in FIG. 2, the waveforms of the U-phase voltage Vu, the V-phase voltage Vv and the W-phase voltage Vw are the shapes of sinusoidal waves the phases of which are shifted 120 degrees. These voltage waveforms and the waveforms of the carrier signals formed with triangular waves are compared, and thus the PWM signals are generated. In FIG. 2, when the voltage waveforms are larger than the carrier signals, the switching elements 511, 512 and 513 in the upper arms of the U-phase leg, the V-phase leg and the W-phase leg are controlled to be on. The switching elements 514, 515 and 516 in the lower arms of the U-phase leg, the V-phase leg and the W-phase leg are operated complementarily to the switching elements 511, 512 and 513 in the upper arms, respectively. Here, the “complementarily” refers to a state where the switching elements in the upper arms of the legs and the switching elements in the lower arms of the legs are alternately turned on and off.

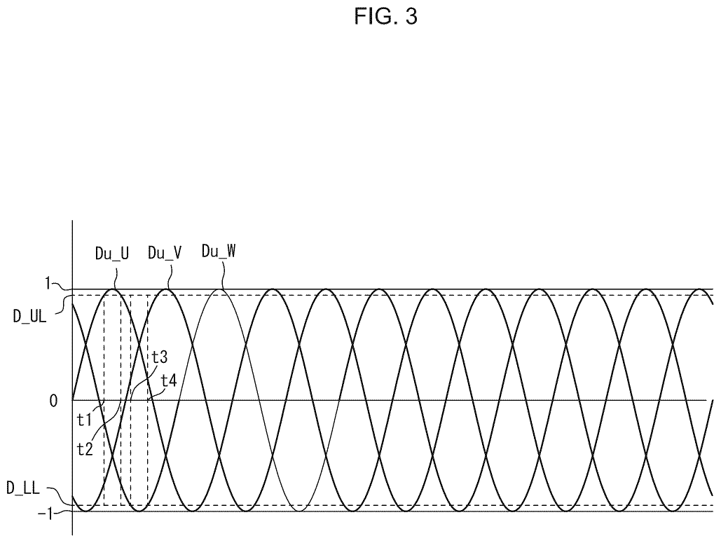

In other words, the voltage signals in the shapes of the sinusoidal waves are subjected to PWM modulation using the carrier signals of the triangular waves, and thus the PWM signals are generated. In FIG. 2, the PWM duty cycle is changed greatly over time, that is, changed in the shape of stairs. The frequency of the carrier signal is increased, and thus a change in the PWM duty cycle over time is finer, with the result that the PWM duty cycle is closer to the sinusoidal wave. Hence, here, the change in the PWM duty cycle over time is shown as a sinusoidal wave having an amplitude of 1 as shown in FIG. 3. FIG. 3 is a diagram showing the waveforms of the PWM duty cycles.

When in the waveforms of the PWM duty cycles in FIG. 3, the PWM duty cycles are positive values, the on periods of the switching elements 511 to 513 in the upper arms of the legs of the phases are long, and the on periods of the switching elements 514 to 516 in the lower arms are short. When the PWM duty cycles are “0”, the on periods of the switching elements 511 to 513 in the upper arms of the legs of the phases are 50%, and the on periods of the switching elements 514 to 516 in the lower arms are 50%. When the PWM duty cycles are “1”, the switching elements in the upper arms are controlled to be constantly on (the on periods are 100%), and when the PWM duty cycles are “−1”, the switching elements in the upper arms are controlled to be constantly off (the on periods are 0%).

When a current is supplied to the motor, the inverter circuit 5 switches the switching elements 511 to 516 on and off to output a voltage of an alternating-current component (in the shapes of the sinusoidal waves). The frequency of the on/off switching of the switching elements 511 to 516 is increased, and thus a switching loss is increased. When the on/off switching time of the switching elements 511 to 516 is short, a surge current several times larger than a current flowing through the inverter circuit 5 flows through the phase coils 201 to 203 of the motor 200, with the result that this causes a large stress on the insulation of the motor 200.

Hence, the inverter circuit 5 performs control for switching the switching elements 511 to 516 on and off for a time longer than a predetermined limit time such that the switching loss as described above is suppressed and a large stress is prevented from being caused on the insulation of the motor 200.

In the inverter circuit 5, the PWM duty cycle adjustment unit 3 adjusts the PWM duty cycles such that the on/off switching time of the switching elements 511 to 516 is prevented from being shorter than the limit time described above. The PWM duty cycles are adjusted as described above, and thus the switching control device 300 can stably operate the motor 200 for a long period of time.

The PWM duty cycles and the on/off switching time will be described. As the PWM duty cycles are increased, the off period of the switching elements is decreased. Likewise, as the PWM duty cycles are decreased, the on period of the switching elements is decreased. In other words, the on/off switching time is decreased.

Hence, in order to allow the motor 200 to rotate stably for a long period of time, the PWM duty cycle adjustment unit 3 sets a permissible range of the PWM duty cycles such that the on/off switching width is prevented from being narrower than a predetermined width. The minimum duty cycle determination unit 31 sets the upper limit of the permissible range to a permissible upper limit D_UL. The minimum duty cycle determination unit 31 sets the lower limit of the permissible range to a permissible lower limit D_LL. When the PWM duty cycle is equal to or less than the permissible lower limit D_LL or equal to or greater than the permissible upper limit D_UL, the minimum duty cycle determination unit 31 determines that an adjustment is needed.

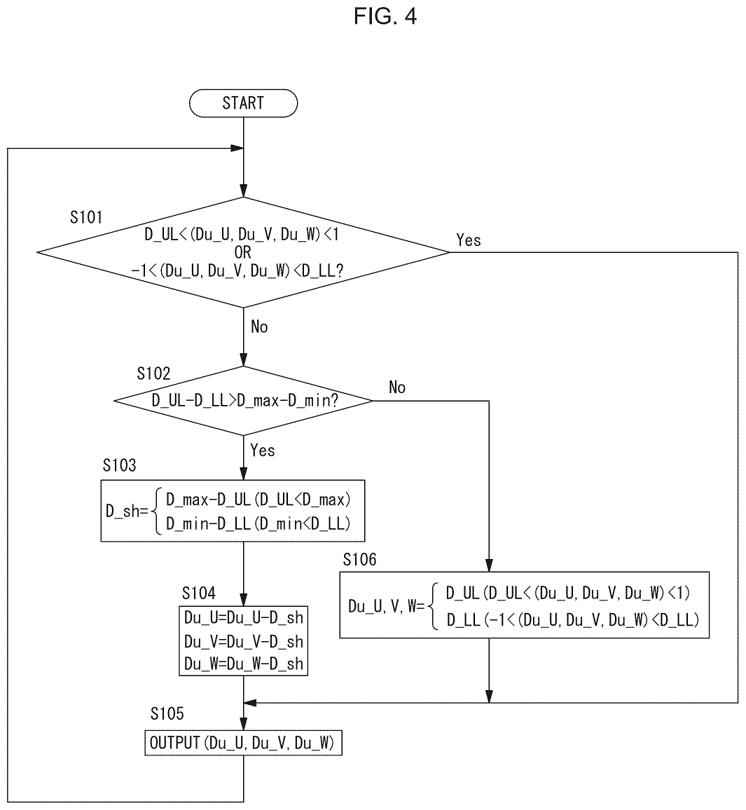

Here, a procedure for adjusting the PWM duty cycles will be described with reference to drawings. FIG. 4 is a flowchart showing the procedure for adjusting the PWM duty cycles. A voltage which has a different phase, and the same voltage waveform is applied to each of the coils 201 to 203 of the phases in the motor 200. Hence, a U-phase duty cycle Du_U, a V-phase duty cycle Du_V and a W-phase duty cycle Du_W have only different phases but have the same waveform (see FIG. 3).

The PWM duty cycle adjustment unit 3 and the minimum duty cycle determination unit 31 have acquired the U-phase duty cycle Du_U, the V-phase duty cycle Du_V and the W-phase duty cycle Du_W. Then, as shown in FIG. 4, the minimum duty cycle determination unit 31 determines whether at least one of the U-phase duty cycle Du_U, the V-phase duty cycle Du_V and the W-phase duty cycle Du_W are greater than the permissible upper limit D_UL and less than “1” or whether at least one of the U-phase duty cycle Du_U, the V-phase duty cycle Du_V and the W-phase duty cycle Du_W are less than the permissible lower limit D_LL and greater than “−1” (step S101).

In step S101, whether at least one of the U-phase duty cycle Du_U, the V-phase duty cycle Du_V and the W-phase duty cycle Du_W are outside the permissible range described above and whether at least one of the U-phase duty cycle Du_U, the V-phase duty cycle Du_V and the W-phase duty cycle Du_W are less than “1” or greater than “−1” are determined. This can also be said to be a determination as to whether all the U-phase duty cycle Du_U, the V-phase duty cycle Du_V and the W-phase duty cycle Du_W are within the permissible range.

When the minimum duty cycle determination unit 31 determines that all the U-phase duty cycle Du_U, the V-phase duty cycle Du_V and the W-phase duty cycle Du_W are within the permissible range (No in step S101), the PWM duty cycle adjustment unit 3 outputs, to the pulse generation unit 4, the U-phase duty cycle Du_U, the V-phase duty cycle Du_V and the W-phase duty cycle Du_W which are the current duty cycles (step S105). After the PWM duty cycles of the phases are output, the processing returns to step S101, and thus the processing is repeated. In other words, when the U-phase duty cycle Du_U, the V-phase duty cycle Du_V and the W-phase duty cycle Du_W are within the permissible range, the PWM duty cycles are not adjusted.

When at least one of the U-phase duty cycle Du_U, the V-phase duty cycle Du_V and the W-phase duty cycle Du_W are outside the permissible range, the PWM duty cycle adjustment unit 3 adjusts the PWM duty cycles.

Hence, when the minimum duty cycle determination unit 31 determines that at least one of the U-phase duty cycle Du_U, the V-phase duty cycle Du_V and the W-phase duty cycle Du_W are greater than the permissible upper limit D_UL and less than “1” or at least one of the U-phase duty cycle Du_U, the V-phase duty cycle Du_V and the W-phase duty cycle Du_W are less than the permissible lower limit D_LL and greater than “−1” (Yes in step S101), the processing is transferred to step S102.

In step S102, the minimum duty cycle determination unit 31 determines whether a difference value between the maximum value D_max and the minimum value D_min of the U-phase duty cycle Du_U, the V-phase duty cycle Du_V and the W-phase duty cycle Du_W is less than a difference value between the permissible upper limit D_UL and the permissible lower limit D_LL. This determination is made, and thus whether the duty cycles of the phases after being adjusted are outside the permissible range is determined. A further description will be given. In the present processing, when the duty cycles of all the phases after being adjusted are within the permissible range, control is performed such that the duty cycles of all the phases are adjusted. In the present processing, when the duty cycles after being adjusted are outside the permissible range, only a part which is currently outside the permissible range is adjusted.

When the minimum duty cycle determination unit 31 determines that the difference value between the maximum value D_max and the minimum value D_min is less than the difference value between the permissible upper limit D_UL and the permissible lower limit D_LL (Yes in step S102), the processing is transferred to step S103.

In step S103, when the maximum value D_max is greater than the permissible upper limit D_UL, the PWM duty cycle adjustment unit 3 sets a shift amount D_Sh to a value obtained by subtracting the permissible upper limit D_UL from the maximum value D_max. When the minimum value D_min is less than the permissible lower limit D_LL, the shift amount D_Sh is set to a value obtained by subtracting the permissible lower limit D_LL from the minimum value D_min. Thereafter, the processing is transferred to step S104.

In step S104, the PWM duty cycle adjustment unit 3 sets values obtained by subtracting the shift amount D_Sh from each of the U-phase duty cycle Du_U, the V-phase duty cycle Du_V and the W-phase duty cycle Du_W which are the current duty cycles to the U-phase duty cycle Du_U, the V-phase duty cycle Du_V and the W-phase duty cycle Du_W which are new duty cycles. Thereafter, the processing is transferred to step S105.

When the difference value between the maximum value D_max and the minimum value D_min is less than the difference value between the permissible upper limit D_UL and the permissible lower limit D_LL, as shown in step S104, the U-phase duty cycle Du_U, the V-phase duty cycle Du_V and the W-phase duty cycle Du_W after being adjusted are within the permissible range.

In step S105, the PWM duty cycle adjustment unit 3 outputs the U-phase duty cycle Du_U, the V-phase duty cycle Du_V and the W-phase duty cycle Du_W to the pulse generation unit 4.

When the minimum duty cycle determination unit 31 determines that the difference value between the maximum value D_max and the minimum value D_min is equal to or greater than the difference value between the permissible upper limit D_UL and the permissible lower limit D_LL (No in step S102), the processing is transferred to step S106.

When the difference value between the maximum value D_max and the minimum value D_min is equal to or greater than the difference value between the permissible upper limit D_UL and the permissible lower limit D_LL, if the adjustment is performed as shown in step S104, at least one of the U-phase duty cycle Du_U, the V-phase duty cycle Du_V and the W-phase duty cycle Du_W are outside the permissible range.

Hence, in step S106, among the U-phase duty cycle Du_U, the V-phase duty cycle Du_V and the W-phase duty cycle Du_W, the duty cycle which is greater than the permissible upper limit D_UL and less than “1” is adjusted to be the permissible upper limit D_UL. Moreover, among the U-phase duty cycle Du_U, the V-phase duty cycle Du_V and the W-phase duty cycle Du_W, the duty cycle which is less than the permissible lower limit D_LL and greater than “−1” is adjusted to be the permissible lower limit D_LL. In step S106, the duty cycle which is within the permissible range is not adjusted. Thereafter, the processing is transferred to step S105. The processing in step S105 is as described above.

In the inverter circuit 5, the duty cycles are adjusted as described above, and thus it is possible to suppress the on/off switching of the switching elements 511 to 516 for a time shorter than the limit time. In this way, it is possible to stably control the rotation of the motor 200 for a long period of time.

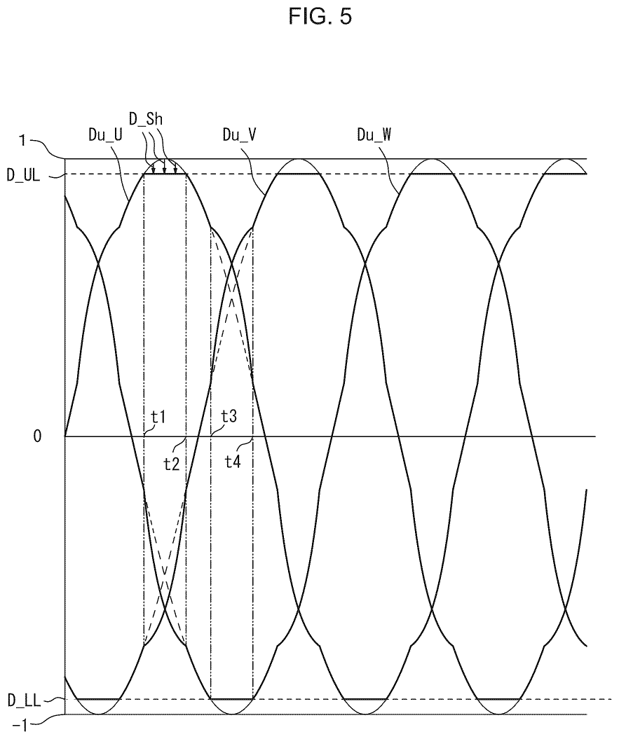

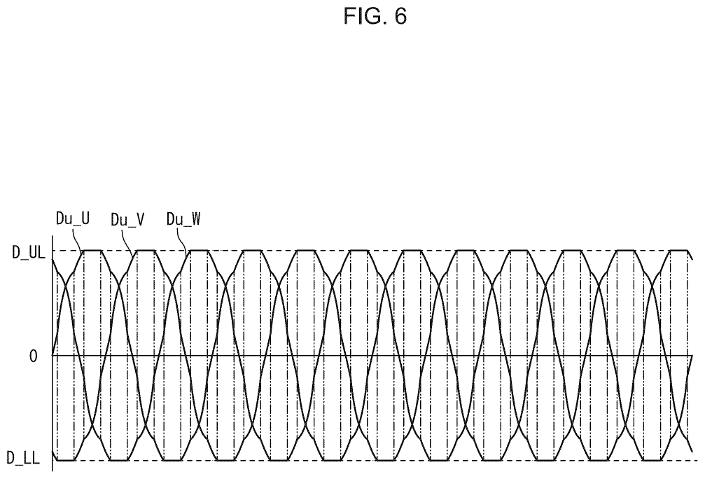

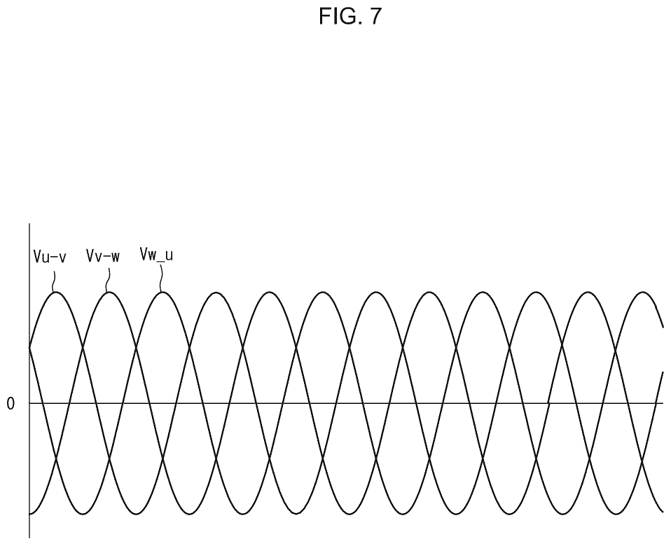

The adjustment of the PWM duty cycles will be specifically described below with reference to drawings. FIG. 5 is an enlarged view of the waveforms of the PWM duty cycles showing the procedure for adjusting the PWM duty cycles. FIG. 6 is a diagram showing the waveforms of the PWM duty cycles after being adjusted. FIG. 7 is a diagram showing the waveforms of line voltages of the brushless DC motor 200.

In the inverter circuit 5, the PWM duty cycles of the waveforms as shown in FIG. 3 are output from the PWM duty cycle conversion unit 2. Here, a part (between time t1 and time t2 in FIG. 5) where the U-phase duty cycle Du_U is greater than the permissible upper limit and a part (between time t3 and time t4 in FIG. 5) where the W-phase duty cycle Du_W is less than the permissible lower limit will be described as an example. Since the U-phase duty cycle Du_U, the V-phase duty cycle Du_V and the W-phase duty cycle Du_W are repeated periodically, they are adjusted by the same operation.

The PWM duty cycle adjustment unit 3 determines that the maximum value D_max is the U-phase duty cycle Du_U and the minimum value D_min is the V-phase duty cycle Du_V between time t1 and time t2 (see FIG. 3).

As shown in FIG. 5, the minimum duty cycle determination unit 31 determines that the U-phase duty cycle Du_U is greater than the permissible upper limit D_UL and less than “1” between time t1 and time t2 (Yes in step S101). Then, the minimum duty cycle determination unit 31 determines that the difference value between the maximum value D_max and the minimum value D_min is less than the difference value between the permissible upper limit D_UL and the permissible lower limit D_LL between time t1 and time t2 (Yes in step S102).

As shown in FIG. 5, between time t1 and time t2, the difference value between the maximum value D_max and the minimum value D_min is less than the difference value between the permissible upper limit D_UL and the permissible lower limit D_LL. Hence, the shift amount D_Sh is set to the value obtained by subtracting the permissible upper limit D_UL from the maximum value D_max (Du_U) (step S103). Then, the PWM duty cycle adjustment unit 3 outputs the U-phase duty cycle Du_U, the V-phase duty cycle Du_V and the W-phase duty cycle Du_W after being adjusted (step S105).

The U-phase duty cycle Du_U, the V-phase duty cycle Du_V and the W-phase duty cycle Du_W are adjusted as described above, and thus the PWM duty cycles between time t1 and time t2 have the waveforms shown in FIGS. 5 and 6. In other words, the U-phase duty cycle Du_U is fixed to the permissible upper limit D_UL, and the V-phase duty cycle Du_V and the W-phase duty cycle Du_W have the waveforms which have been shifted downward by the shift amount D_Sh.

Between time t2 and time t3, the U-phase duty cycle Du_U, the V-phase duty cycle Du_V and the W-phase duty cycle Du_W are within the permissible range (No in step S101). Hence, the U-phase duty cycle Du_U, the V-phase duty cycle Du_V and the W-phase duty cycle Du_W are used without being processed, and the waveforms of the PWM duty cycles shown in FIGS. 5 and 6 are the same as the waveforms of the PWM duty cycles shown in FIG. 3.

Then, between time t3 and time t4, the W-phase duty cycle Du_W is greater than “−1” and greater than the permissible lower limit D_LL. Then, the difference value between the maximum value D_max and the minimum value D_min is less than the difference value between the permissible upper limit D_UL and the permissible lower limit D_LL. Hence, the shift amount D_Sh is set to a value obtained by subtracting the permissible lower limit D_LL from the minimum value D_min (Du_W) (step S103 in FIG. 4). Then, values obtained by subtracting the shift amount D_Sh from each of the U-phase duty cycle Du_U, the V-phase duty cycle Du_V and the W-phase duty cycle Du_W are set to the U-phase duty cycle Du_U, the V-phase duty cycle Du_V and the W-phase duty cycle Du_W after being adjusted (step S104).

Between time t3 and time t4, the shift amount D_Sh is a negative value. Hence, between time t3 and time t4, the W-phase duty cycle Du_W is fixed to the permissible lower limit D_LL, and the U-phase duty cycle Du_U and the V-phase duty cycle Du_V have the waveforms which have been shifted upward by the shift amount D_Sh (see FIGS. 5 and 6).

When the PWM duty cycles are adjusted as shown in FIGS. 5 and 6, the difference between the PWM duty cycles such as a difference between the U-phase duty cycle Du_U and the V-phase duty cycle Du_V is not changed before and after being adjusted. The waveforms of the PWM signals correspond to the voltage waveforms of the voltages applied from the switching control device 300 to the motor 200. Hence, the voltage waveforms of the voltages of the U phase, the V phase and the W phase are the same as the waveforms of the PWM signals.

A line voltage (hereinafter referred to as a U_V line voltage Vu_v) between the U-phase voltage and the V-phase voltage, a line voltage (hereinafter referred to as a V_W line voltage Vv_w) between the V-phase voltage and the W-phase voltage and a line voltage (hereinafter referred to as a W_U line voltage Vw_u) between the W-phase voltage and the U-phase voltage which are output from the inverter circuit 5 driven by the U-phase duty cycle Du_U, the V-phase duty cycle Du_V and the W-phase duty cycle Du_W are the same as those before the PWM duty cycles are adjusted (see FIG. 7). In this way, the PWM duty cycles are adjusted, and thus the on/off switching for a short time is suppressed without the line voltages being changed, with the result that it is possible to suppress a surge current. Consequently, it is possible to stably drive the motor 200 to rotate for a long period of time.

When the PWM duty cycle adjustment unit 3 performs the adjustment in step S106, though the line voltages are changed, a surge current can be suppressed. Hence, though the accuracy of the rotation of the motor 200 may be lowered, it is possible to stably drive the motor 200 to rotate for a long period of time.

### First Variation

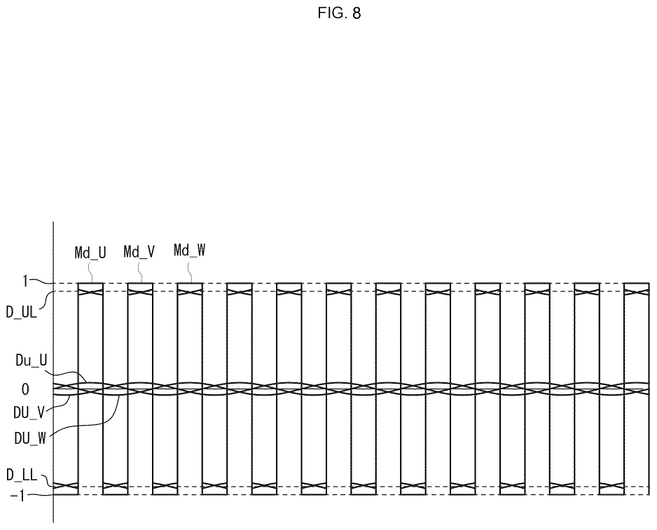

A first variation of the motor system will be described with reference to drawings. In the present variation, the motor system 100 has the same configuration as that shown in FIG. 1. Hence, the description of the configuration of the motor system 100 is omitted. FIG. 8 is a diagram showing the waveforms of PWM duty cycles.

In the above description, the PWM duty cycles may be outside the permissible range. When as shown in FIG. 8, the U-phase duty cycle Du_U, the V-phase duty cycle Du_V and the W-phase duty cycle Du_W are small, a surge current is easily generated. Even when the PWM duty cycles of the phases are changed, the line voltages are not changed as long as the difference value between the duty cycles of the phases is the same.

Hence, in the motor system 100, the voltage command computation unit 1 performs line modulation for increasing or decreasing the voltage command signals VL_U, VL_V and VL_W to generate the voltage command signals which have been subjected to the line modulation. Then, the PWM duty cycle conversion unit 2 generates the PWM duty cycles from the voltage command signals subjected to the line modulation, and thus in the motor system 100, the occurrence of a surge current is suppressed.

The voltage command signals of the phases which have been modulated are referred to as a modulated U-phase voltage command signal Mv_U, a modulated V-phase voltage command signal Mv_V and a modulated W-phase voltage command signal Mv_W.

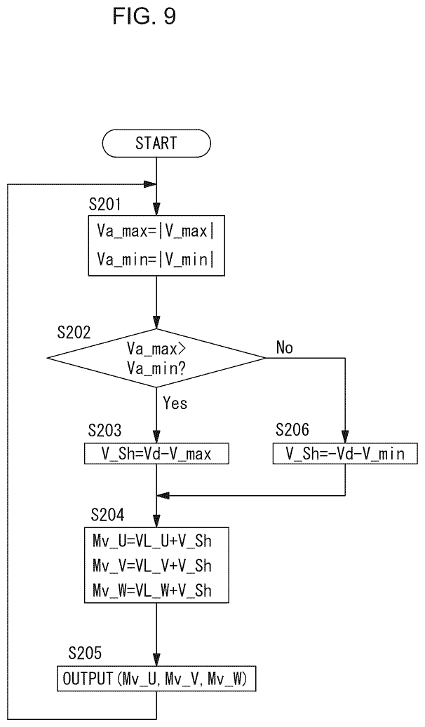

The line modulation will first be described. FIG. 9 is a flowchart showing a procedure for performing the line modulation on the voltage command signals. The voltage command computation unit 1 first acquires the maximum value V_max and the minimum value V_min from among the voltage command signals VL_U, VL_V and VL_W of the phases at a certain time (step S201). Whether the absolute value Va_max of the maximum value is greater than the absolute value Va_min of the minimum value is determined (step S202). When the absolute value Va_max of the maximum value is greater than the absolute value Va_min of the minimum value (Yes in step 202), the voltage command computation unit 1 sets, to the shift amount V_Sh, the maximum value of the voltage capable of being supplied which is a value, in this case, obtained by subtracting the maximum value V_max from the amplitude “Vd” of the voltage command signal (step S203).

Thereafter, the voltage command computation unit 1 adds the shift amount V_Sh to each of the U-phase voltage command signal VL_U, the V-phase voltage command signal VL_V and the W-phase voltage command signal VL_W to generate the modulated U-phase voltage command signal Mv_U, the modulated V-phase voltage command signal Mv_V and the modulated W-phase voltage command signal Mv_W (step S204).

Then, the voltage command computation unit 1 outputs the modulated U-phase voltage command signal Mv_U, the modulated V-phase voltage command signal Mv_V and the modulated W-phase voltage command signal Mv_W to the PWM duty cycle conversion unit 2 (step S205).

When the absolute value Va_min of the minimum value of the voltage is greater than the absolute value Va_max of the maximum value (No in step S202), the voltage command computation unit 1 sets, to the shift amount V_Sh, the minimum value of the voltage capable of being supplied which is a value, in this case, obtained by subtracting the minimum value V_min from “—Vd” (step S206). Thereafter, the processing is transferred to step S204. The processing in step S204 is the same as that described previously.

The PWM duty cycle conversion unit 2 determines the PWM duty cycles by the procedure as described above based on the voltage command signals subjected to the line modulation. The PWM duty cycles of the phases subjected to the modulation are referred to as a modulated U-phase duty cycle Md_U, a modulated V-phase duty cycle Md_V and a modulated W-phase duty cycle Md_W.

The waveforms of the PWM duty cycles obtained by converting from the voltage command signals subjected to the line modulation are shown in FIG. 8. In the PWM duty cycles obtained by converting from the voltage command signals subjected to the line modulation, the PWM duty cycle of a part of the maximum value (Vd) or the minimum value (−Vd) of the voltage which can be supplied by the voltage command signal is “1” or “−1”.

The PWM duty cycle adjustment unit 3 adjusts the modulated U-phase duty cycle Md_U, the modulated V-phase duty cycle Md_V and the modulated W-phase duty cycle Md_W. The adjustment of the modulated U-phase duty cycle Md_U, the modulated V-phase duty cycle Md_V and the modulated W-phase duty cycle Md_W will be described below with reference to drawings.

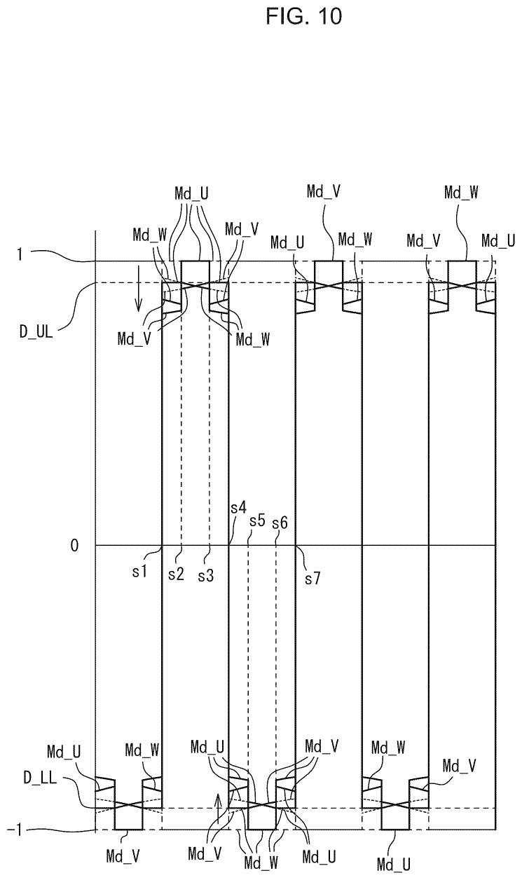

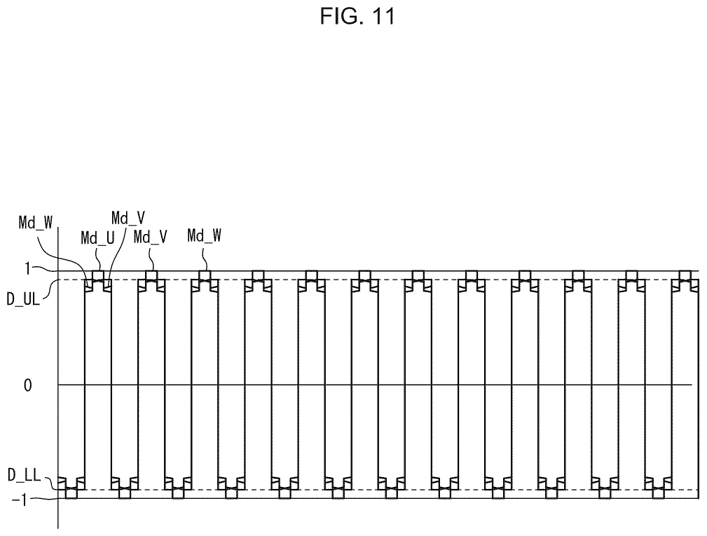

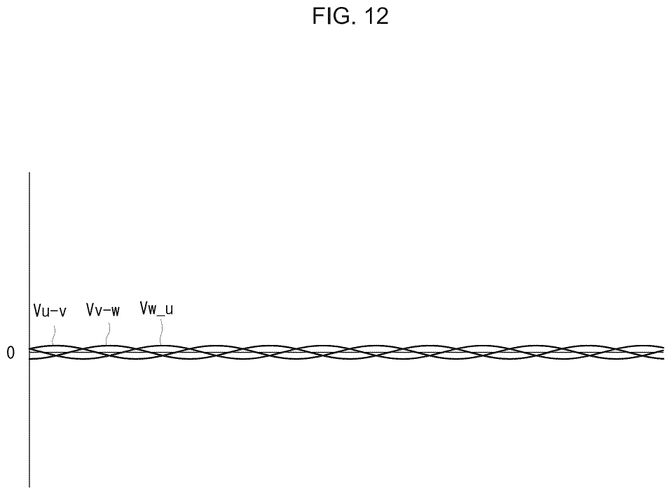

FIG. 10 is an enlarged view of the waveforms of the PWM duty cycles showing a procedure for adjusting the PWM duty cycles. FIG. 11 is a diagram showing the waveforms of the PWM duty cycles after being adjusted. FIG. 12 is a diagram showing the waveforms of line voltages of the motor 200.

The adjustment of the duty cycles is performed according to the flowchart shown in FIG. 4. Hence, a description will be given according to the flowchart shown in FIG. 4 with reference to the waveforms of the PWM duty cycles shown in FIG. 10. The case of a change from time s1 to time s7 in the waveforms of the PWM duty cycles shown in FIG. 10 will be described. In FIG. 4, the U-phase duty cycle Du_U, the V-phase duty cycle Du_V and the W-phase duty cycle Du_W are replaced by the modulated U-phase duty cycle Md_U, the modulated V-phase duty cycle Md_V and the modulated W-phase duty cycle Md_W, respectively.

As shown in FIG. 10, between time s1 and time s2 and between time s3 and time s4, the minimum duty cycle determination unit 31 determines that the modulated U-phase duty cycle Md_U is the maximum value D_max, and here, the maximum value D_max is “1”. The minimum duty cycle determination unit 31 determines that the minimum value D_min is the modulated V-phase duty cycle Md_V (between time s1 and time s2) and is the modulated W-phase duty cycle Md_W (between time s3 and time s4). Then, the minimum duty cycle determination unit 31 determines that the modulated W-phase duty cycle Md_W (between time s1 and time s2) or the modulated V-phase duty cycle Md_V (between time s3 and time s4) is greater than the permissible upper limit D_UL and less than “1” (Yes in step S101).

The minimum duty cycle determination unit 31 determines that the difference value between the maximum value D_max and the minimum value D_min is less than the difference value between the permissible upper limit D_UL and the permissible lower limit D_LL (Yes in step S102). The processing is transferred to step S103.

Since the maximum value D_max is greater than the permissible upper limit D_UL, the PWM duty cycle adjustment unit 3 sets a value obtained by subtracting the permissible upper limit D_UL from the maximum value D_max to the shift amount D_Sh (step S103). Then, the PWM duty cycle adjustment unit 3 sets values obtained by subtracting the shift amount D_Sh from each of the modulated U-phase duty cycle Md_U, the modulated V-phase duty cycle Md_V and the modulated W-phase duty cycle Md_W which are the current duty cycles to the modulated U-phase duty cycle Md_U, the modulated V-phase duty cycle Md_V and the modulated W-phase duty cycle Md_W which are new duty cycles (step S104). Then, the PWM duty cycle adjustment unit 3 outputs, to the pulse generation unit 4, the modulated U-phase duty cycle Md_U, the modulated V-phase duty cycle Md_V and the modulated W-phase duty cycle Md_W which are new duty cycles (step S105).

As described previously, when the PWM duty cycles are “1”, the on periods of the switching elements in the upper arms are 100% (the on periods of the switching elements in the lower arms are 0%). In other words, the switching elements are not switched on and off, and thus the switching elements are not affected by switching for a short time. Hence, when the PWM duty cycles are “1”, the PWM duty cycles can be used without being adjusted. Between time s2 and time s3, the modulated V-phase duty cycle Md_V and the modulated W-phase duty cycle Md_W are less than the permissible upper limit D_UL. Therefore, the PWM duty cycle adjustment unit 3 determines that no adjustment is needed, and outputs, to the pulse generation unit 4, the modulated U-phase duty cycle Md_U, the modulated V-phase duty cycle Md_V and the modulated W-phase duty cycle Md_W which are the current duty cycles (step S105).

As shown in FIG. 10, between time s4 and time s5 and between time s6 and time s7, the minimum duty cycle determination unit 31 determines that the modulated W-phase duty cycle Md_W is the minimum value D_min, and here, the minimum value D_min is “1”. The minimum duty cycle determination unit 31 determines that the maximum value D_max is the modulated U-phase duty cycle Md_U (between time s4 and time s5) and is the modulated V-phase duty cycle Md_V (between time s6 and time s7). Then, the minimum duty cycle determination unit 31 determines that the modulated V-phase duty cycle Md_V (between time s4 and time s5) or the modulated U-phase duty cycle Md_U (between time s6 and time s7) is less than the permissible lower limit D_LL and greater than “−1” (Yes in step S101).

The minimum duty cycle determination unit 31 determines that the difference value between the maximum value D_max and the minimum value D_min is less than the difference value between the permissible upper limit D_UL and the permissible lower limit D_LL (Yes in step S102). The processing is transferred to step S103.

Since the minimum value D_min is less than the permissible lower limit D_LL, the PWM duty cycle adjustment unit 3 sets a value obtained by subtracting the permissible upper limit D_UL from the minimum value D_min to the shift amount D_Sh (step S103). Then, the PWM duty cycle adjustment unit 3 sets values obtained by subtracting the shift amount D_Sh from each of the modulated U-phase duty cycle Md_U, the modulated V-phase duty cycle Md_V and the modulated W-phase duty cycle Md_W which are the current duty cycles to the modulated U-phase duty cycle Md_U, the modulated V-phase duty cycle Md_V and the modulated W-phase duty cycle Md_W which are new duty cycles (step S104). Then, the PWM duty cycle adjustment unit 3 outputs, to the pulse generation unit 4, the modulated U-phase duty cycle Md_U, the modulated V-phase duty cycle Md_V and the modulated W-phase duty cycle Md_W which are new duty cycles (step S105).

As described previously, when the PWM duty cycles are “−1”, the on periods of the switching elements in the upper arms are 0% (the on periods of the switching elements in the lower arms are 100%). In other words, the switching elements are not switched on and off, and thus the switching elements are not affected by switching for a short time. Hence, when the PWM duty cycles are “−1”, the PWM duty cycles can be used without being adjusted. Between time s5 and time s6, the modulated V-phase duty cycle Md_V and the modulated W-phase duty cycle Md_W are less than the permissible upper limit D_UL. Therefore, the PWM duty cycle adjustment unit 3 determines that no adjustment is needed, and outputs, to the pulse generation unit 4, the modulated U-phase duty cycle Md_U, the modulated V-phase duty cycle Md_V and the modulated W-phase duty cycle Md_W which are the current duty cycles (step S105).

As described above, the PWM duty cycle adjustment unit 3 adjusts the duty cycles, and thus the modulated U-phase duty cycle Md_U, the modulated V-phase duty cycle Md_V and the modulated W-phase duty cycle Md_W have the waveforms as shown in FIG. 11.

As described above, the PWM duty cycles of the phases are adjusted, and thus the on/off switching for a short time is suppressed without the line voltages being changed (see FIG. 12), with the result that it is possible to suppress a surge current. Consequently, it is possible to stably drive the motor 200 to rotate for a long period of time.

### Second Variation

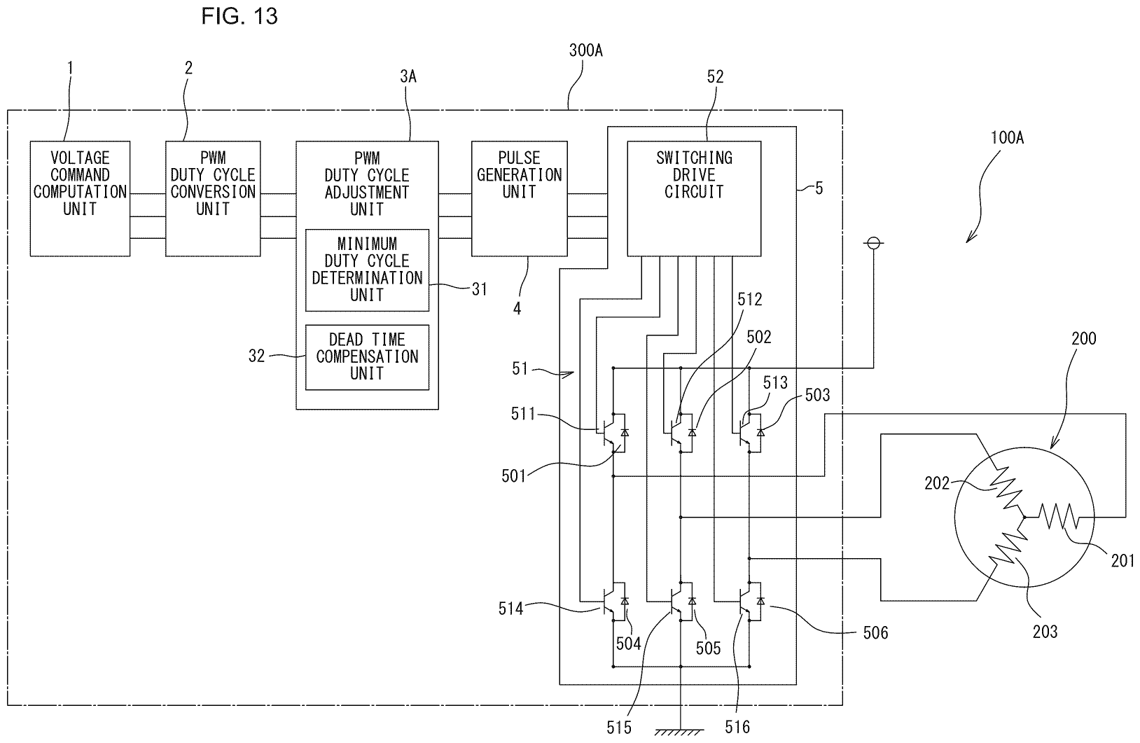

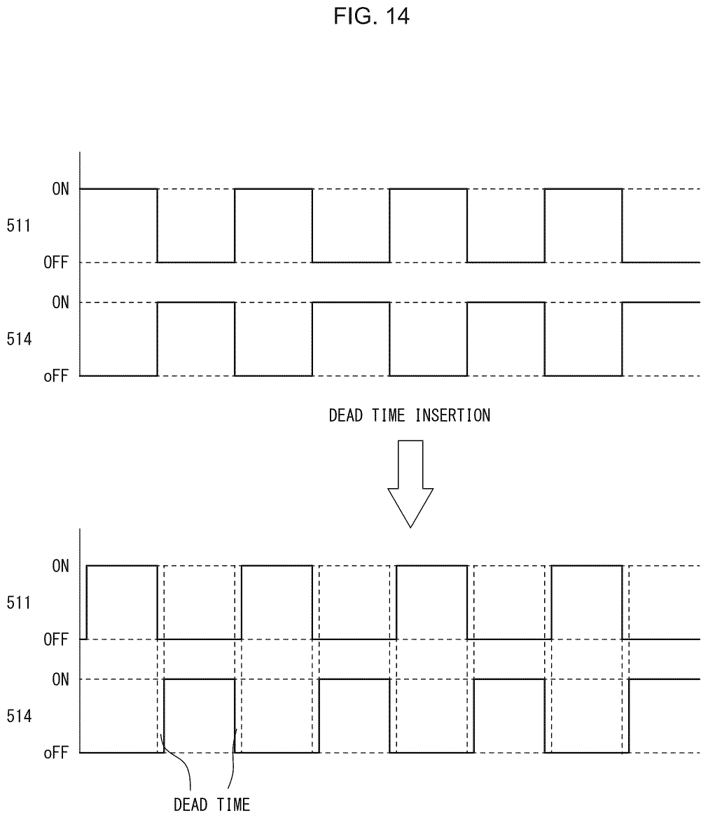

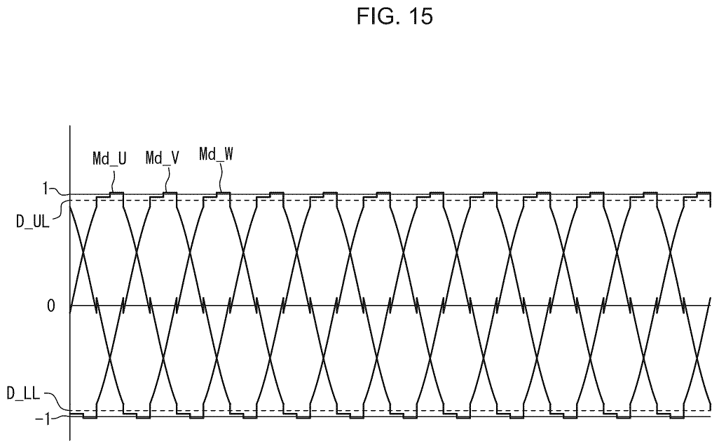

A second variation of the motor system will be described with reference to drawings. FIG. 13 is a schematic configuration diagram of a motor system 100A in the second variation. FIG. 14 is a diagram showing an example of an operation for inserting a dead time. FIG. 15 is a diagram showing the waveforms of PWM duty cycles on which line modulation and dead time compensation have been performed.

The motor system 100A shown in FIG. 13 differs from the motor system 100 shown in FIG. 1 in that the PWM duty cycle adjustment unit 3A of a switching control device 300A includes a dead time compensation unit 32. The parts other than the PWM duty cycle adjustment unit 3A of the motor system 100A have the same configurations as in the motor system 100. Hence, in the motor system 100A, substantially the same parts as in the motor system 100 are identified with the same symbols, and the detailed description of the same parts are omitted.

As shown in FIG. 2, the PWM duty cycle conversion unit 2 generates the PWM duty cycles such that the switching element 511 (512 and 513) in the upper arm and the switching element 514 (515 and 516) in the lower arm are complementarily switched on and off. However, in the actual switching elements 511 and 514, a delay occurs after reception of the PWM signals until the actual switching elements 511 and 514 are switched on or off. When such a delay occurs, if the actual switching elements 511 and 514 are complementarily switched on and off, the switching element 511 (512 and 513) and the switching element 514 (515 and 516) are simultaneously switched on, with the result that a short circuit may occur.

Hence, the PWM duty cycle conversion unit 2 adjusts the PWM signals such that periods in which the switching elements in the upper arms and the lower arms of the legs of the phases are simultaneously turned off occur at parts where the operations of the switching elements are switched. FIG. 14 shows the PWM signals for the switching element 511 in the upper arm and the switching element 514 in the lower arm of the U phase in a certain period of time. For ease of description, FIG. 14 shows a steady drive state where the switching element 511 is switched between the PWM duty cycle of “1” and the PWM duty cycle of “0”. In actuality, as shown in FIG. 2, the PWM duty cycles fluctuate over time.

In the PWM signals shown in FIG. 14, when the switching element 514 is controlled to be on, the timing at which the switching element 514 is switched on is shifted to the timing at which the switching element 511 is completely switched off. When the switching element 511 is controlled to be on, the timing at which the switching element 511 is switched on is shifted to the timing at which the switching element 514 is completely switched off.

In this way, a dead time at which the switching elements in the upper arm and the switching elements in the lower arm are simultaneously off is inserted into the PWM signals. The dead time is inserted, and thus in the legs of the phases, the switching elements in the upper arm and the switching elements in the lower arm are prevented from being simultaneously on, with the result that a short circuit current is prevented from flowing. Likewise, in the V-phase leg and the W-phase leg, the dead time is inserted.

Although in the waveforms shown in FIG. 14, the timing at which each of the switching elements rises to the on state is shifted later, the present disclosure is not limited to this configuration. The timing at which each of the switching elements falls to the off state may be shifted forward to insert the dead time. Alternatively, the timing at which each of the switching elements falls to the off state is shifted forward, and the timing at which each of the switching elements rises to the on state is shifted later, with the result that the dead time may be inserted.

The dead time is inserted, and thus an error occurs between the voltages which are actually output to the motor 200 and the voltage command signals. In the PWM duty cycle adjustment unit 3A of the motor system 100A, the dead time compensation unit 32 adjusts the PWM duty cycles to correct the error between the voltages output to the motor 200 and the voltage command signals.

In the motor system 100A, the voltage command computation unit 1 performs the line modulation on the voltage command signals, and the PWM duty cycle conversion unit 2 generates the PWM duty cycles based on the voltage command signals on which the line modulation has been performed. Then, the dead time compensation unit 32 of the PWM duty cycle adjustment unit 3A performs the dead time compensation on the PWM duty cycles supplied from the PWM duty cycle conversion unit 2.

FIG. 15 shows the waveforms of the PWM duty cycles on which the line modulation and the dead time compensation have been performed. In the PWM duty cycles on which the dead time compensation has been performed, in parts where the PWM duty cycles are modulated by the line modulation to “1” or “−1”, a part in which “1” or “−1” does not continue may be generated (see FIG. 15).

As shown in FIG. 15, as a result of the line modulation and the dead time compensation being performed, a part in which the maximum PWM duty cycle exceeds “1”, and a part in which the minimum PWM duty cycle falls below “−1” may be generated. In the motor system 100A, when the PWM duty cycle exceeds “1”, the same operation as when the PWM duty cycle is “1” is actually performed, that is, the switching element is controlled to be constantly on. When the PWM duty cycle falls below “−1”, the same operation as when the PWM duty cycle is “−1” is actually performed, that is, the switching element is controlled to be constantly off.

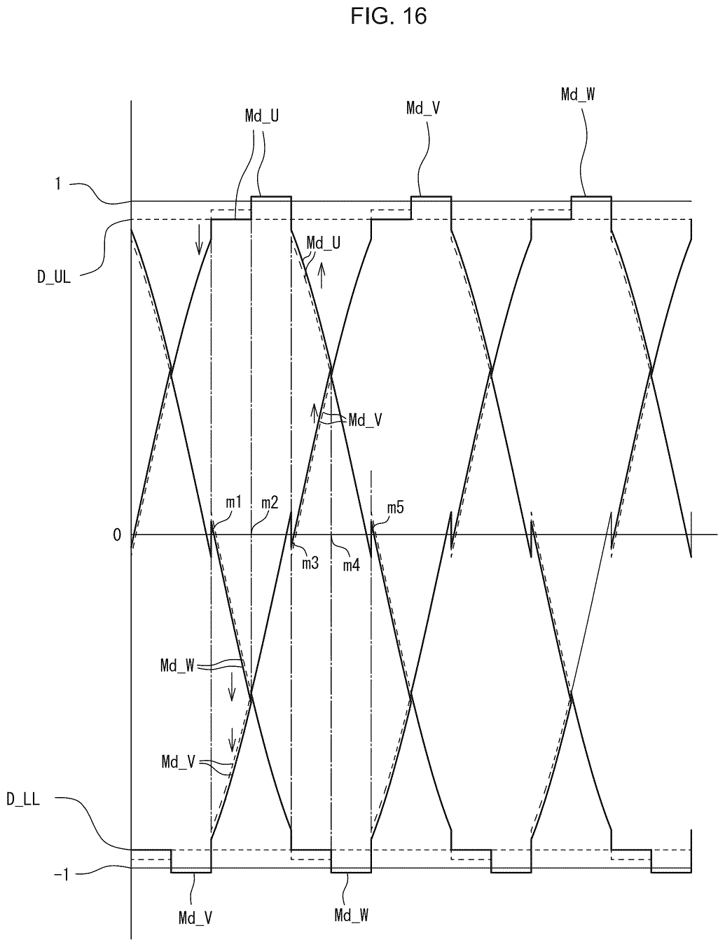

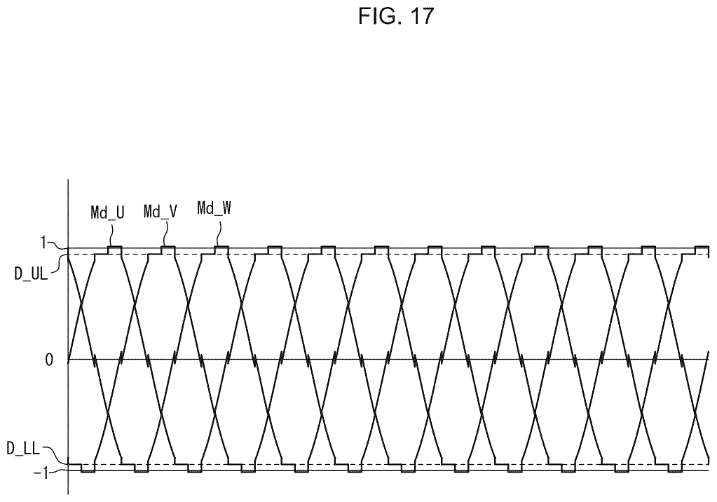

The PWM duty cycle adjustment unit 3A of the motor system 100A in the present variation further performs the adjustment by the procedure shown in FIG. 4 on the PWM duty cycles which have the waveforms as shown in FIG. 15 and on which the line modulation and the dead time compensation have been performed. The procedure for the adjustment of the PWM duty cycles on which the line modulation and the dead time compensation have been performed will be described below with reference to drawings. FIG. 16 is an enlarged view of the waveforms of the PWM duty cycles showing the procedure for adjusting the PWM duty cycle. FIG. 17 is a diagram showing the waveforms of the PWM duty cycles after being adjusted.

As shown in FIG. 16, a description will be given with reference to the PWM duty cycles between time m1 and time m5. Between time m1 and time m2, the minimum duty cycle determination unit 31 determines that the modulated U-phase duty cycle Md_U is the maximum value D_max. The minimum duty cycle determination unit 31 determines that the minimum value D_min is the modulated V-phase duty cycle Md_V. Then, the minimum duty cycle determination unit 31 determines that the modulated U-phase duty cycle Md_U (maximum value D_max) is greater than the permissible upper limit D_UL and less than “1” (Yes in step S101).

The minimum duty cycle determination unit 31 determines that the difference value between the maximum value D_max and the minimum value D_min is less than the difference value between the permissible upper limit D_UL and the permissible lower limit D_LL (Yes in step S102). The processing is transferred to step S103.

Since the maximum value D_max is greater than the permissible upper limit D_UL, the PWM duty cycle adjustment unit 3A sets a value obtained by subtracting the permissible upper limit D_UL from the maximum value D_max to the shift amount D_Sh (step S103). Then, the PWM duty cycle adjustment unit 3A sets values obtained by subtracting the shift amount D_Sh from each of the modulated U-phase duty cycle Md_U, the modulated V-phase duty cycle Md_V and the modulated W-phase duty cycle Md_W which are the current duty cycles to the modulated U-phase duty cycle Md_U, the modulated V-phase duty cycle Md_V and the modulated W-phase duty cycle Md_W which are new duty cycles (step S104). Then, the PWM duty cycle adjustment unit 3A outputs, to the pulse generation unit 4, the modulated U-phase duty cycle Md_U, the modulated V-phase duty cycle Md_V and the modulated W-phase duty cycle Md_W which are new duty cycles (step S105).

Between time m2 and time m3, the minimum duty cycle determination unit 31 determines that the maximum value D_max is greater than “1” (No in step S101). The PWM duty cycle adjustment unit 3A outputs, to the pulse generation unit 4, the modulated U-phase duty cycle Md_U, the modulated V-phase duty cycle Md_V and the modulated W-phase duty cycle Md_W which are the current duty cycles (step S105). When the duty cycles of the phases are output, they may be output after the modulated U-phase duty cycle Md_U which is the maximum value D_max is adjusted to “1.”

As shown in FIG. 16, between time m3 and time m4, the minimum duty cycle determination unit 31 determines that the modulated W-phase duty cycle Md_W is the minimum value D_min. The minimum duty cycle determination unit 31 determines that the modulated U-phase duty cycle Md_U is the maximum value D_max. Then, the minimum duty cycle determination unit 31 determines that the minimum value D_min (=the modulated W-phase duty cycle Md_W) is less than the permissible lower limit D_LL and greater than “−1” (Yes in step S101).

The minimum duty cycle determination unit 31 determines that the difference value between the maximum value D_max and the minimum value D_min is less than the difference value between the permissible upper limit D_UL and the permissible lower limit D_LL (Yes in step S102). The processing is transferred to step S103.

Since the minimum value D_min is less than the permissible lower limit D_LL, the PWM duty cycle adjustment unit 3A sets a value obtained by subtracting the permissible lower limit D_LL from the minimum value D_min to the shift amount D_Sh (step S103). Then, the PWM duty cycle adjustment unit 3A sets the values obtained by subtracting the shift amount D_Sh from each of the modulated U-phase duty cycle Md_U, the modulated V-phase duty cycle Md_V and the modulated W-phase duty cycle Md_W which are the current duty cycles to the modulated U-phase duty cycle Md_U, the modulated V-phase duty cycle Md_V and the modulated W-phase duty cycle Md_W which are new duty cycles (step S104). Then, the PWM duty cycle adjustment unit 3 outputs, to the pulse generation unit 4, the modulated U-phase duty cycle Md_U, the modulated V-phase duty cycle Md_V and the modulated W-phase duty cycle Md_W which are new duty cycles (step S105).

Between time m4 and time m5, the minimum duty cycle determination unit 31 determines that the minimum value D_min is less than “−1” (No in step S101). Then, the PWM duty cycle adjustment unit 3A outputs, to the pulse generation unit 4, the modulated U-phase duty cycle Md_U, the modulated V-phase duty cycle Md_V and the modulated W-phase duty cycle Md_W which are the current duty cycles (step S105). When the duty cycles of the phases are output, they may be output after the modulated W-phase duty cycle Md_W which is the minimum value D_min is adjusted to “−1”.

The modulated U-phase duty cycle Md_U, the modulated V-phase duty cycle Md_V and the modulated W-phase duty cycle Md_W have the same waveforms the phases of which are shifted, and thus the PWM duty cycle adjustment unit 3A can adjust the duty cycles by the same procedure.

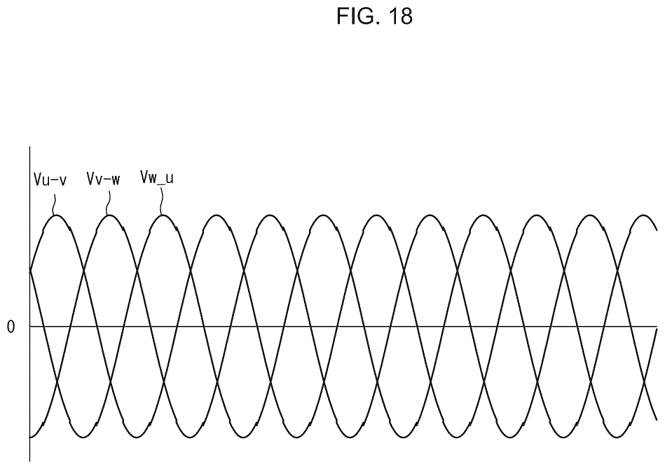

The PWM duty cycles of the phases are adjusted as described above, and thus the PWM duty cycles of the waveforms as shown in FIG. 17 are generated. The line voltages of the motor 200 when the inverter main circuit 51 is driven using the PWM duty cycles shown in FIG. 17 based on the PWM signals from the pulse generation unit 4 have the waveforms as shown in FIG. 18. FIG. 18 is a diagram showing the waveforms of line voltages of the motor 200. Although in FIG. 18, an error in the waveforms caused by the dead time compensation occurs partially, the line voltages have substantially the same waveforms as those before being adjusted. A short circuit in the switching elements in the upper arm and the switching elements in the lower arm and the on/off switching for a short time are suppressed, and thus it is possible to suppress a surge current. Consequently, the decline in the performance of the motor 200 is suppressed, and thus it is possible to stably drive the motor 200 to rotate for a long period of time.

### Third Variation

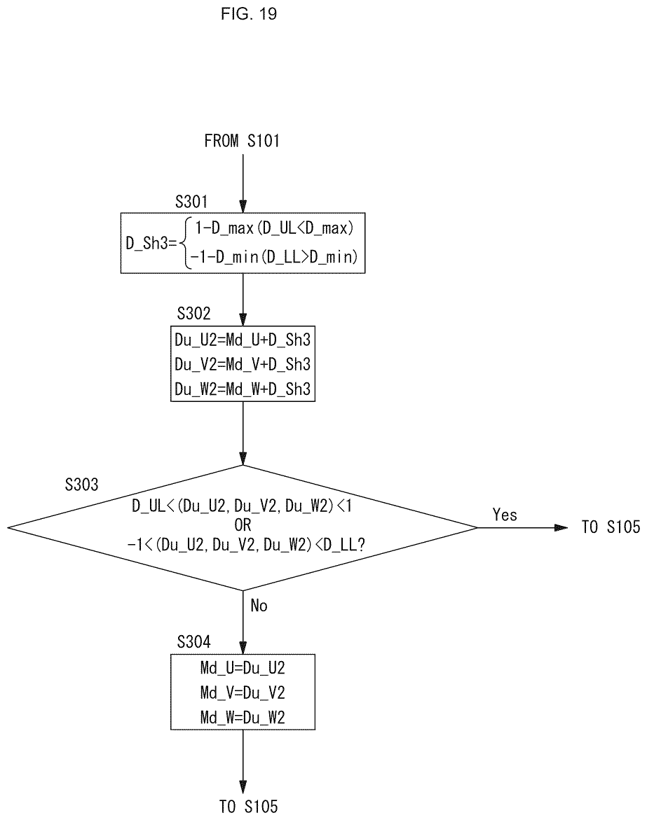

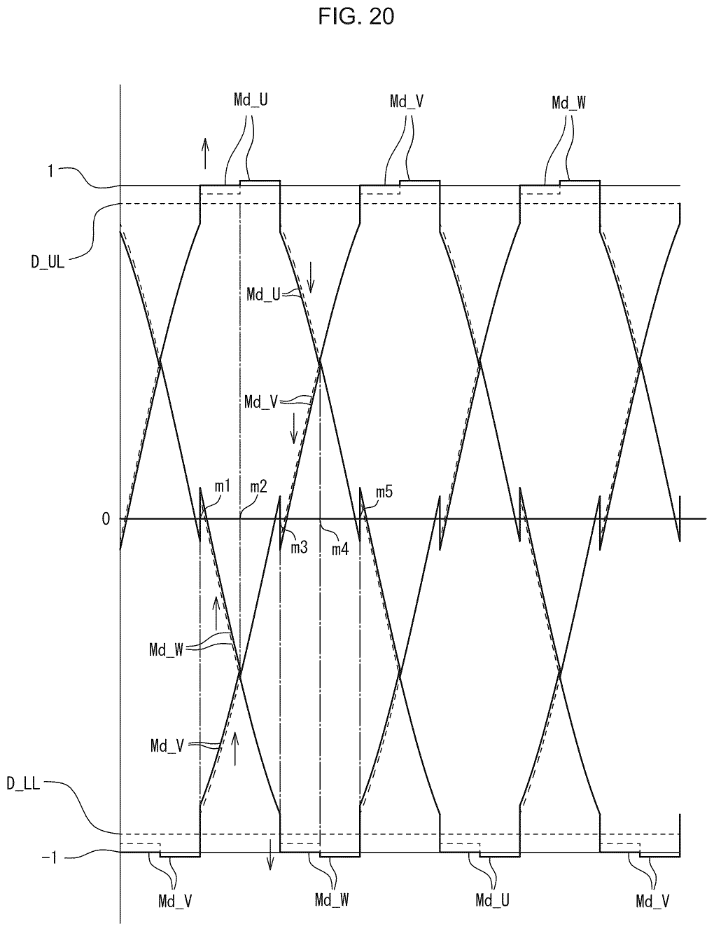

A third variation of the motor system will be described with reference to drawings. FIG. 19 is a flowchart showing a procedure for adjusting PWM duty cycles in the third variation. FIG. 20 is an enlarged view of waveforms in the procedure for adjusting the PWM duty cycles using the flowchart shown in FIG. 19. The flowchart shown in FIG. 19 shows processing which branches from a state where a determination of Yes is made in step S101 in the flowchart shown in FIG. 4.

The flowchart shown in FIG. 19 is assumed to be processed in parallel to steps S102 to S104 or steps S102 and S106 in the flowchart shown in FIG. 4. The PWM duty cycles shown in FIG. 20 show a case where the PWM duty cycles shown in FIG. 16 are adjusted according to the processing in the flowchart shown in FIG. 19. In FIG. 19, as in the second embodiment, the U-phase duty cycle Du_U, the V-phase duty cycle Du_V and the W-phase duty cycle Du_W can be replaced by the modulated U-phase duty cycle Md_U, the modulated V-phase duty cycle Md_V and the modulated W-phase duty cycle Md_W.

In the processing in FIG. 19, when the maximum value D_max is greater than the permissible upper limit D_UL, the PWM duty cycle adjustment unit 3A sets a value obtained by subtracting the maximum value D_max from “1” to a shift amount D_Sh3. When the minimum value D_min is less than the permissible lower limit D_LL, the PWM duty cycle adjustment unit 3A sets a value obtained by subtracting the minimum value D_min from “−1” to the shift amount D_Sh3 (step S301).

Thereafter, the PWM duty cycle adjustment unit 3A adds the shift amount D_Sh3 to the modulated U-phase duty cycle Md_U, the modulated V-phase duty cycle Md_V and the modulated W-phase duty cycle Md_W which are the current duty cycles to generate a temporary U-phase duty cycle Du_U2, a temporary V-phase duty cycle Du_V2 and a temporary W-phase duty cycle Du_W2 (step S302).

Then, the minimum duty cycle determination unit 31 determines whether at least one of the temporary U-phase duty cycle Du_U2, the temporary V-phase duty cycle Du_V2 and the temporary W-phase duty cycle Du_W2 are greater than the permissible upper limit D_UL and less than “1” or are less than the permissible lower limit D_LL and greater than “−1” (step S303).

When in step S303, at least one of the temporary U-phase duty cycle Du_U2, the temporary V-phase duty cycle Du_V2 and the temporary W-phase duty cycle Du_W2 satisfy the condition described above (Yes in step S303), the minimum duty cycle determination unit 31 determines that at least one of the temporary U-phase duty cycle Du_U2, the temporary V-phase duty cycle Du_V2 and the temporary W-phase duty cycle Du_W2 are outside the permissible range or are not “1” or “−1”.

Then, the PWM duty cycle adjustment unit 3A discards the temporary U-phase duty cycle Du_U2, the temporary V-phase duty cycle Du_V2 and the temporary W-phase duty cycle Du_W2 calculated by the processing in steps S301 to S303, and outputs the modulated U-phase duty cycle Md_U, the modulated V-phase duty cycle Md_V and the modulated W-phase duty cycle Md_W calculated in steps S102 to S104 or steps S102 and S106 in FIG. 4 (step S105).

When the temporary U-phase duty cycle Du_U2, the temporary V-phase duty cycle Du_V2 and the temporary W-phase duty cycle Du_W2 do not satisfy the condition in step S303 (No in step S303), the minimum duty cycle determination unit 31 determines that the temporary U-phase duty cycle Du_U2, the temporary V-phase duty cycle Du_V2 and the temporary W-phase duty cycle Du_W2 are within the permissible range or are “1” or “−1”.

Then, the PWM duty cycle adjustment unit 3A sets the temporary U-phase duty cycle Du_U2, the temporary V-phase duty cycle Du_V2 and the temporary W-phase duty cycle Du_W2 to the modulated U-phase duty cycle Md_U, the modulated V-phase duty cycle Md_V and the modulated W-phase duty cycle Md_W which are new duty cycles (step S304), and outputs them to pulse generation unit 4 (step S105). When in step S304, the modulated U-phase duty cycle Md_U, the modulated V-phase duty cycle Md_V and the modulated W-phase duty cycle Md_W which are new duty cycles are generated, the modulated U-phase duty cycle Md_U, the modulated V-phase duty cycle Md_V and the modulated W-phase duty cycle Md_W generated in steps S102 to S104 or step S106 are discarded.

The PWM duty cycles are adjusted as described above, and thus the maximum value D_max can be fixed to “1” or the minimum value D_min can be fixed to “−1”. In this way, a switching loss is suppressed, and a short circuit in the switching elements in the upper arm and the switching elements in the lower arm and the on/off switching for a short time are suppressed, with the result that it is possible to suppress a surge current. Consequently, the lowering of the operation of the motor 200 is suppressed, and thus it is possible to stably drive the motor 200 to rotate for a long period of time.

The processing for adjusting the PWM duty cycles shown in FIG. 19 will be specifically described with reference to FIG. 20. As shown in FIG. 20, a description will be given with reference to the PWM duty cycles between time m1 and time m5.

Between time m1 and time m2, the minimum duty cycle determination unit 31 determines that the modulated U-phase duty cycle Md_U is the maximum value D_max. The minimum duty cycle determination unit 31 determines that the minimum value D_min is the modulated V-phase duty cycle Md_V. Then, the minimum duty cycle determination unit 31 determines that the modulated U-phase duty cycle Md_U (maximum value D_max) is greater than the permissible upper limit D_UL and less than “1” (Yes in step S101).

Since the maximum value D_max is greater than the permissible upper limit D_UL, the PWM duty cycle adjustment unit 3A sets a value obtained by subtracting the maximum value D_max from “1” to the shift amount D_Sh3 (step S301). Then, the PWM duty cycle adjustment unit 3A sets values obtained by adding the shift amount D_Sh3 to each of the modulated U-phase duty cycle Md_U, the modulated V-phase duty cycle Md_V and the modulated W-phase duty cycle Md_W which are the current duty cycles to the temporary U-phase duty cycle Du_U2, the temporary V-phase duty cycle Du_V2 and the temporary W-phase duty cycle Du_W2 (step S302).

Then, the minimum duty cycle determination unit 31 determines that each of the temporary U-phase duty cycle Du_U2, the temporary V-phase duty cycle Du_V2 and the temporary W-phase duty cycle Du_W2 does not satisfy the condition in which the duty cycle is greater than the permissible upper limit D_UL and less than “1” or the duty cycles is less than the permissible lower limit D_LL and greater than “−1” (No in step S303).

Then, in step S304, the PWM duty cycle adjustment unit 3A sets the temporary U-phase duty cycle Du_U2, the temporary V-phase duty cycle Du_V2 and the temporary W-phase duty cycle Du_W2 to the modulated U-phase duty cycle Md_U, the modulated V-phase duty cycle Md_V and the modulated W-phase duty cycle Md_W (step S304), and outputs them to the pulse generation unit 4 (step S105).

Between time m2 and time m3, the minimum duty cycle determination unit 31 determines that the maximum value D_max is greater than “1” (No in step S101). The PWM duty cycle adjustment unit 3A outputs, to the pulse generation unit 4, the modulated U-phase duty cycle Md_U, the modulated V-phase duty cycle Md_V and the modulated W-phase duty cycle Md_W which are the current duty cycles (step S105). When the duty cycles of the phases are output, they may be output after the modulated U-phase duty cycle Md_U which is the maximum value D_max is adjusted to “1”.

As shown in FIG. 20, between time m3 and time m4, the minimum duty cycle determination unit 31 determines that the modulated W-phase duty cycle Md_W is the minimum value D_min. The minimum duty cycle determination unit 31 determines that the modulated U-phase duty cycle Md_U is the maximum value D_max. Then, the minimum duty cycle determination unit 31 determines that the minimum value D_min (=the modulated W-phase duty cycle Md_W) is less than the permissible lower limit D_LL and greater than “−1” (Yes in step S101).

Since the minimum value D_min is less than the permissible lower limit D_LL, the PWM duty cycle adjustment unit 3 sets a value obtained by subtracting the minimum value D_min from “−1” to the shift amount D_Sh3 (step S301). Then, the PWM duty cycle adjustment unit 3 sets values obtained by adding the shift amount D_Sh3 to each of the modulated U-phase duty cycle Md_U, the modulated V-phase duty cycle Md_V and the modulated W-phase duty cycle Md_W which are the current duty cycles to the temporary U-phase duty cycle Du_U2, the temporary V-phase duty cycle Du_V2 and the temporary W-phase duty cycle Du_W2 (step S302).

Then, the minimum duty cycle determination unit 31 determines that each of the temporary U-phase duty cycle Du_U2, the temporary V-phase duty cycle Du_V2 and the temporary W-phase duty cycle Du_W2 does not satisfy the condition in which the duty cycle is greater than the permissible upper limit D_UL and less than “1” or the duty cycles is less than the permissible lower limit D_LL and greater than “−1” (No in step S303).

Then, in step S304, the PWM duty cycle adjustment unit 3A sets the temporary U-phase duty cycle Du_U2, the temporary V-phase duty cycle Du_V2 and the temporary W-phase duty cycle Du_W2 to the modulated U-phase duty cycle Md_U, the modulated V-phase duty cycle Md_V and the modulated W-phase duty cycle Md_W (step S304), and outputs them to the pulse generation unit 4 (step S105).

Between time m4 and time m5, the minimum duty cycle determination unit 31 determines that the minimum value D_min is less than “−1” (No in step S101). Hence, the PWM duty cycle adjustment unit 3A outputs, to the pulse generation unit 4, the modulated U-phase duty cycle Md_U, the modulated V-phase duty cycle Md_V and the modulated W-phase duty cycle Md_W which are the current duty cycles (step S105). When the duty cycles of the phases are output, they may be output after the modulated W-phase duty cycle Md_W which is the maximum value D_max is adjusted to “−1”.

The modulated U-phase duty cycle Md_U, the modulated V-phase duty cycle Md_V and the modulated W-phase duty cycle Md_W have the same waveforms the phases of which are shifted, and thus the PWM duty cycle adjustment unit 3A can adjust the duty cycles by the same procedure.

The PWM duty cycles are adjusted as described above, and thus the maximum value D_max can be fixed to “1” or the minimum value D_min can be fixed to “−1”. In this way, a switching loss is suppressed, and a short circuit in the switching elements in the upper arm and the switching elements in the lower arm and the on/off switching for a short time are suppressed, with the result that it is possible to suppress a surge current. Consequently, the lowering of the operation of the motor 200 is suppressed, and thus it is possible to stably drive the motor 200 to rotate for a long period of time.

Although the flowchart shown in FIG. 19 is processed in parallel to steps S102 to S104 and S106 in the flowchart shown in FIG. 4, the present disclosure is not limited to this configuration. For example, when in the processing shown in FIG. 19, a determination of No is made in step S303, the processing may be transferred to step S102. In this way, the processing in FIG. 19 is prioritized, and thus the parallel processing can be reduced. Steps S102 to S104 in FIG. 14 may be prioritized. Preferably, in this case, a step for determining whether the processing in step S102 to S104 shown in FIG. 4 is appropriate is additionally provided. A determination may be performed with another criterion before and after step S102 to select processing.

### OTHERS

In the embodiments of the present disclosure, various changes can be made as necessary without departing from technical ideas in the scope of claims. The various embodiments described above may be combined as necessary as long as there is no contradiction. The embodiments described above are merely examples of the embodiment of the present disclosure, and the meanings of terms in the present disclosure and constituent elements are not limited to those described in the above embodiments.

Although in the embodiments described above, the switching control device has been described using, as examples, the configurations in which the switching control device 300 for driving the brushless DC motor 200 is adopted, the present disclosure is not limited to these configurations. The present disclosure can be widely adopted for control on an inverter circuit using switching elements.

The switching control device (300) described above may include: a PWM duty cycle conversion unit (2) configured to convert voltage command signals of three phases (U, V and W) into PWM duty cycles; a PWM duty cycle adjustment unit (3) configured to simultaneously adjust the PWM duty cycles of the three phases at the same time using the same adjustment value; a pulse generation unit (4) configured to generate pulse signals from the PWM duty cycles adjusted by the PWM duty cycle adjustment unit (3); and an inverter circuit (6) configured to include a plurality of switching elements (501 to 506) that are driven by the pulse signals generated by the pulse generation unit (4) (first configuration).

In the switching control device of the first configuration, the PWM duty cycle adjustment unit (3) may set the adjustment value such that a line voltage has a sinusoidal wave that fluctuates at a predetermined period (second configuration).

In the switching control device of the first or second configuration, when at least one of the PWM duty cycles exceed an upper limit (D_UL) of a permissible range, the PWM duty cycle adjustment unit (3) may set, to the adjustment value, a difference value between the maximum PWM duty cycle of the PWM duty cycles exceeding the upper limit (D_UL) and the upper limit (D_UL) of the permissible range (third configuration).

In the switching control device of any one of the first to third configurations, when at least one of the PWM duty cycles fall below a lower limit (D_LL) of a permissible range, the PWM duty cycle adjustment unit (3) may set, to the adjustment value, a difference value between the minimum PWM duty cycle of the PWM duty cycles falling below the lower limit (D_LL) and the lower limit (D_LL) of the permissible range (fourth configuration).

The switching control device of the first or second configuration further includes: a voltage command computation unit (1) configured to perform line modulation to set the voltage command signal of the maximum phase within a predetermined period to the maximum value (Vd) of a voltage capable of being supplied. The PWM duty cycle conversion unit (2) may generate a PWM duty cycle such that the PWM duty cycle is “1” when the voltage command signal is the maximum value (Vd) of the voltage capable of being supplied, and when the PWM duty cycle of a phase other than “1” exceeds an upper limit (D_UL) of a permissible range, the PWM duty cycle adjustment unit (3) may set, to the adjustment value, a difference value between the PWM duty cycle exceeding the upper limit of the permissible range and “1” (fifth configuration).

The switching control device of any one of the first, second and fifth configurations further includes: a voltage command computation unit (1) configured to perform line modulation to set the voltage command signal of the minimum phase within a predetermined period to the minimum value (−Vd) of a voltage capable of being supplied. The PWM duty cycle conversion unit (2) may generate a PWM duty cycle such that the PWM duty cycle is “−1” when the voltage command signal is the minimum value (−Vd) of the voltage capable of being supplied, and when the PWM duty cycle of a phase other than “−1” falls below a lower limit (D_LL) of a permissible range, the PWM duty cycle adjustment unit (3) may set, to the adjustment value, a difference value between the PWM duty cycle falling below the lower limit (D_LL) of the permissible range and “−1” (sixth configuration).

In the switching control device of any one of the first to sixth configurations, the PWM duty cycle adjustment unit (3) may adjust only a PWM duty cycle of an adjustable phase in an adjustable range (seventh configuration).

The switching control device of any one of the first to fifth configurations may further include: a dead time compensation unit (32) configured to perform processing that compensates for a dead time for the PWM duty cycle before being adjusted by the PWM duty cycle adjustment unit (3) (eighth configuration).

In the switching control device of any one of the first to eighth configurations, the inverter circuit (5) may include, for each of the three phases, a leg that includes a switching element (501 to 503) in an upper arm and a switching element (504 to 506) in a lower arm (ninth configuration).

The motor system (100) described above may include: the switching control device (300) of the ninth configuration; and a motor (200) configured to be controlled by the switching control device (300) (tenth configuration).

### LIST OF REFERENCE SYMBOLS

1 voltage command computation unit
2 PWM duty cycle conversion unit
3, 3A PWM duty cycle adjustment unit
4 pulse generation unit
5 inverter circuit
31 minimum duty cycle determination unit
32 dead time compensation unit
51 inverter main circuit
52 switching drive circuit
100, 100A motor system
200 brushless DC motor
201 U-phase coil
202 V-phase coil
203 W-phase coil
300 switching control device
501 to 506 free-wheeling diode
511 to 516 switching element

1. A switching control device comprising:
a PWM duty cycle conversion unit configured to convert voltage command signals of three phases into PWM duty cycles;
a PWM duty cycle adjustment unit configured to simultaneously adjust the PWM duty cycles of the three phases at a same time using a same adjustment value;
a pulse generation unit configured to generate pulse signals from the PWM duty cycles adjusted by the PWM duty cycle adjustment unit; and
an inverter circuit configured to include a plurality of switching elements that are driven by the pulse signals generated by the pulse generation unit.

2. The switching control device according to claim 1,
wherein the PWM duty cycle adjustment unit sets the adjustment value such that a line voltage has a sinusoidal wave that fluctuates at a predetermined period.

3. The switching control device according to claim 1,
wherein when at least one of the PWM duty cycles exceed an upper limit of a permissible range, the PWM duty cycle adjustment unit sets, to the adjustment value, a difference value between a maximum PWM duty cycle of the PWM duty cycles exceeding the upper limit and the upper limit of the permissible range.

4. The switching control device according to claim 1,
wherein when at least one of the PWM duty cycles fall below a lower limit of a permissible range, the PWM duty cycle adjustment unit sets, to the adjustment value, a difference value between a minimum PWM duty cycle of the PWM duty cycles falling below the lower limit and the lower limit of the permissible range.

5. The switching control device according to claim 1, further comprising:
a voltage command computation unit configured to perform line modulation to set the voltage command signal of a maximum phase within a predetermined period to a maximum value of a voltage capable of being supplied,
wherein the PWM duty cycle conversion unit generates a PWM duty cycle such that the PWM duty cycle is “1” when the voltage command signal is the maximum value of the voltage capable of being supplied, and
when a PWM duty cycle of a phase other than “1” exceeds an upper limit of a permissible range, the PWM duty cycle adjustment unit sets, to the adjustment value, a difference value between the PWM duty cycle exceeding the upper limit of the permissible range and “1”.

6. The switching control device according to claim 1, further comprising:
a voltage command computation unit configured to perform line modulation to set the voltage command signal of a minimum phase within a predetermined period to a minimum value of a voltage capable of being supplied,
wherein the PWM duty cycle conversion unit generates a PWM duty cycle such that the PWM duty cycle is “−1” when the voltage command signal is the minimum value of the voltage capable of being supplied, and
when a PWM duty cycle of a phase other than “−1” falls below a lower limit of a permissible range, the PWM duty cycle adjustment unit sets, to the adjustment value, a difference value between the PWM duty cycle falling below the lower limit of the permissible range and “−1”.

7. The switching control device according to claim 1,
wherein the PWM duty cycle adjustment unit adjusts only a PWM duty cycle of an adjustable phase in an adjustable range.

8. The switching control device according to claim 1, further comprising:
a dead time compensation unit configured to perform processing that compensates for a dead time for the PWM duty cycle before being adjusted by the PWM duty cycle adjustment unit.

9. The switching control device according to claim 1,
wherein the inverter circuit includes, for each of the three phases, a leg that includes a switching element in an upper arm and a switching element in a lower arm.

10. A motor system comprising:
the switching control device according to claim 9; and
a motor configured to be controlled by the switching control device.
